(19) United States
(12) Patent Application Publication
(10) Pub. No.: US 2020/0339764 A1
(43) Pub. Date: Oct. 29, 2020

(54) A METHOD, TREATED OR MODIFIED POLYMER AND ARTICLE OF MANUFACTURE

(71) Applicant: Rapid Powders Limited, Staffordshire (GB)

(72) Inventor: Mo SONG, Leicestershire (GB)

(21) Appl. No.: 16/630,345

(22) PCT Filed: Jul. 6, 2018
(86) PCT No.: PCT/GB2018/051932

§ 371 Date: Jan. 10, 2020

(30) Foreign Application Priority Data
Jul. 11, 2017 (GB) 1711148.5

(51) Int. Cl. C08J 3/12; C08J 3/05; C08J 3/205; C08K 3/34; C08K 3/04; C08K 3/22

(52) U.S. Cl. CPC C08J 3/128; C08J 3/05; C08J 3/205; C08K 3/346; C08K 3/041; C08K 2003/2244; C08K 3/042; C08J 2367/02; C08J 2377/00; C08K 2201/011; C08K 2201/005; C08K 3/22

(57) ABSTRACT

A method for producing a treated or modified polymer, the method comprising:
combining a first liquid and at least one additive material to produce a first liquid and additive material mixture;
agitating the first liquid and additive material mixture to disperse the at least one additive material throughout the first liquid;
combining a second liquid and a polymer to wet the polymer to produce a wetted polymer; and
combining the agitated first liquid and additive material mixture with the wetted polymer to produce a treated or modified polymer.

### TECHNOLOGICAL FIELD

Examples of the present disclosure relate to a method, a treated or modified polymer and an article of manufacture. In particular, they relate to a method for producing a treated or modified polymer, a treated or modified polymer produced using the method and an article of manufacture produced using the treated or modified polymer.

### BACKGROUND

Various methods are available to combine fillers such as glass fibres, clays, conductive carbon particles and metal particles with a wide range of polymers. In industrial practice, the polymer in the form of pellets is melted and mixed with the filler under shear conditions in a twin-screw extruder and the compounded composite material is extruded into thin strands which are cooled and chopped into pellets for re-sale or further use.

Other compounding methods include premixing of the polymer and filler in a separate high shear mixer. The high shear mixing process often partially melts the polymer and the partially compounded material is then fed into a single screw extruder or twin roll mixer for the final compounding step depending on the polymer and required final form.

Such mixing techniques may not achieve optimum distribution of filler particles within the polymer even if the composite material is intensively and often repeatedly shear mixed to improve the dispersion of filler in the polymer. For certain polymers, such as polyamides, such high temperature—high shear processing can also degrade the polymer itself leading to poor properties and durability.

Further difficulties are experienced where the filler is very finely divided and have lateral dimensions measured in a few microns to nanometers. Such fillers, due to their very large surface area to volume ratio have a tendency to agglomerate and are particularly difficult to disperse within polymers using conventional techniques. Such filler materials are often treated with surfactants to aid dispersion; however, this approach may not be acceptable for certain valuable markets for polymers particularly packaging for food and beverages.

### BRIEF SUMMARY

According to various, but not necessarily all, examples of the disclosure there is provided a method for producing a treated or modified polymer, the method comprising: combining a first liquid and at least one additive material to produce a first liquid and additive material mixture;

agitating the first liquid and additive material mixture to disperse the at least one additive material throughout the first liquid;

combining a second liquid and a polymer to wet the polymer to produce a wetted polymer; and

combining the agitated first liquid and additive material mixture with the wetted polymer to produce a treated or modified polymer.

According to various, but not necessarily all, examples of the disclosure there is provided a treated or modified polymer comprising polymer particles having additive particles adhered to the outside of the polymer particles.

According to various, but not necessarily all, examples of the disclosure there is provided a treated or modified polymer produced using a method described herein.

According to various, but not necessarily all, examples of the disclosure there is provided an article of manufacture comprising a treated or modified polymer as described herein.

According to various, but not necessarily all, examples of the disclosure there is provided and apparatus comprising means for producing a treated or modified polymer using a method as described herein.

According to various, but not necessarily all, examples of the disclosure there is provided a method for producing a modified thermoplastic polymer 10, the method comprising: combining water with graphene to produce a water and graphene mixture; agitating the water and graphene mixture to homogenously disperse the graphene throughout the water;

combining water with a thermoplastic polymer to wet the thermoplastic polymer to produce a wetted thermoplastic polymer; and

combining the water and graphene mixture with the wetted thermoplastic polymer, wherein the weight of the graphene, as a proportion of the weight of the thermoplastic polymer, is greater than 0 percent and less than or equal to 5 percent.

According to various, but not necessarily all, examples of the disclosure there is provided a method for producing a treated or modified polymer, the method comprising: combining a first liquid and at least one additive material to produce a first liquid and additive material mixture;
agitating the first liquid and additive material mixture using high shear mixing techniques or ultra sonication to disperse the at least one additive material throughout the first liquid;

combining a second liquid and a fine thermal polymer powder and by agitation produce a wetted polymer mixture or slurry; and

combining the agitated first liquid and additive material mixture with the wetted polymer powder to produce a treated or modified polymer.

According to various, but not necessarily all, examples of the disclosure there is provided a method for producing a treated or modified thermoplastic polymer, the method comprising:

combining a first liquid and at least one additive material to produce a first liquid and additive material mixture;

agitating the first liquid and additive material mixture to disperse the at least one additive material throughout the first liquid;

combining a second liquid and a thermoplastic polymer to produce a thermoplastic polymer slurry; and

combining the agitated first liquid and additive material mixture with the thermoplastic polymer slurry to produce a treated or modified thermoplastic polymer comprising thermoplastic polymer particles having additive particles adhered to the outside of the thermoplastic polymer particles.

According to various, but not necessarily all, examples of the disclosure there is provided a method for producing a treated or modified thermoplastic polymer, the method comprising:

combining a first liquid and at least one additive material to produce a first liquid and additive material mixture;

agitating the first liquid and additive material mixture to disperse the at least one additive material throughout the first liquid;

combining a second liquid and a thermoplastic polymer to produce a thermoplastic polymer slurry; and

combining the agitated first liquid and additive material mixture with the thermoplastic polymer slurry to produce a treated or modified thermoplastic polymer, wherein the at least one additive material is chemically inert to the thermoplastic polymer in the method.

According to various, but not necessarily all, embodiments of the invention there is provided examples as claimed in the appended claims.

### BRIEF DESCRIPTION

For a better understanding of various examples that are useful for understanding the detailed description, reference will now be made by way of example only to the accompanying drawings in which:

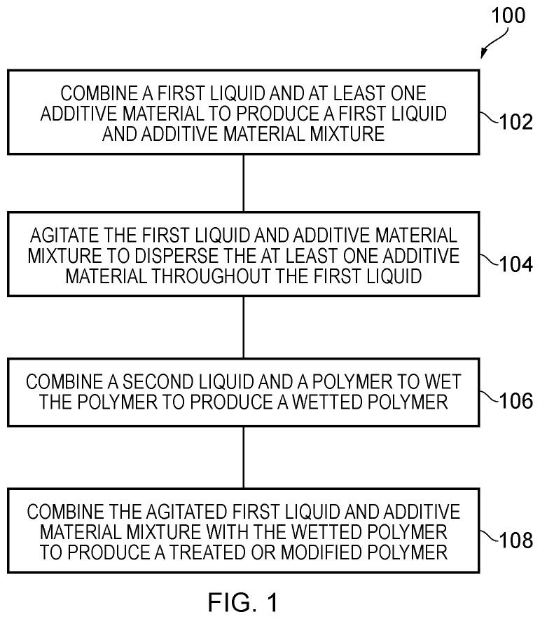

FIG. 1 illustrates a method for producing a treated or modified polymer;

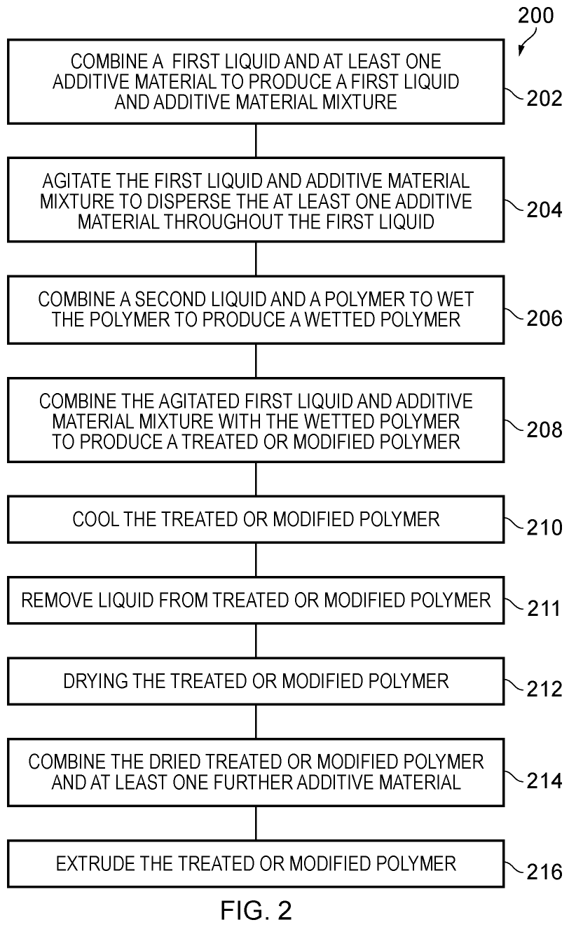

FIG. 2 illustrates a method for producing a treated or modified polymer;

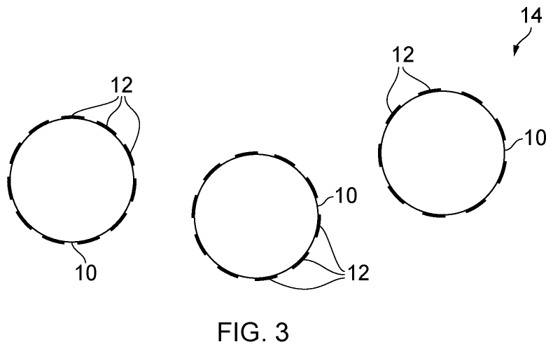

FIG. 3 illustrates a treated or modified polymer;

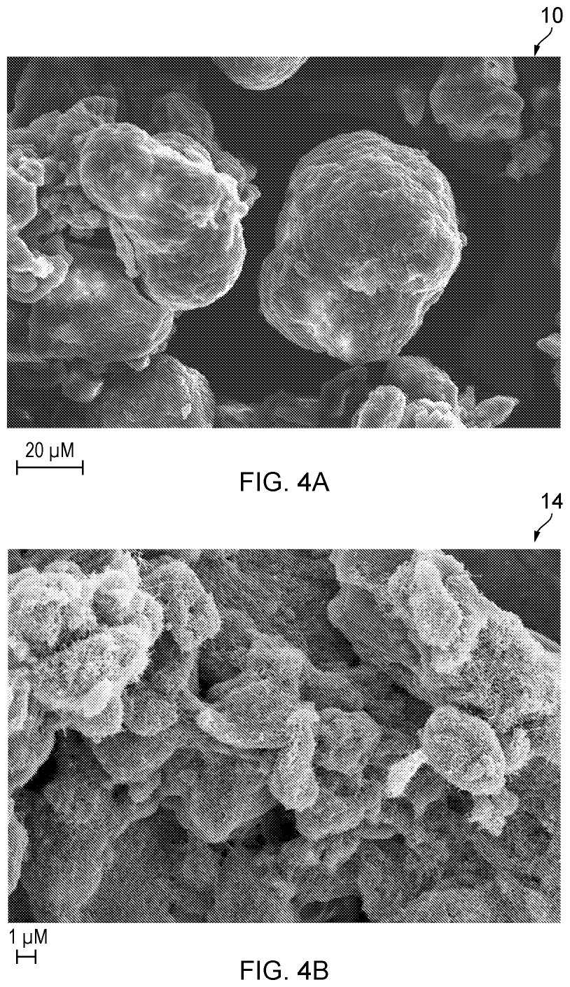

FIG. 4A illustrates a polymer;

FIG. 4B illustrates a treated or modified polymer;

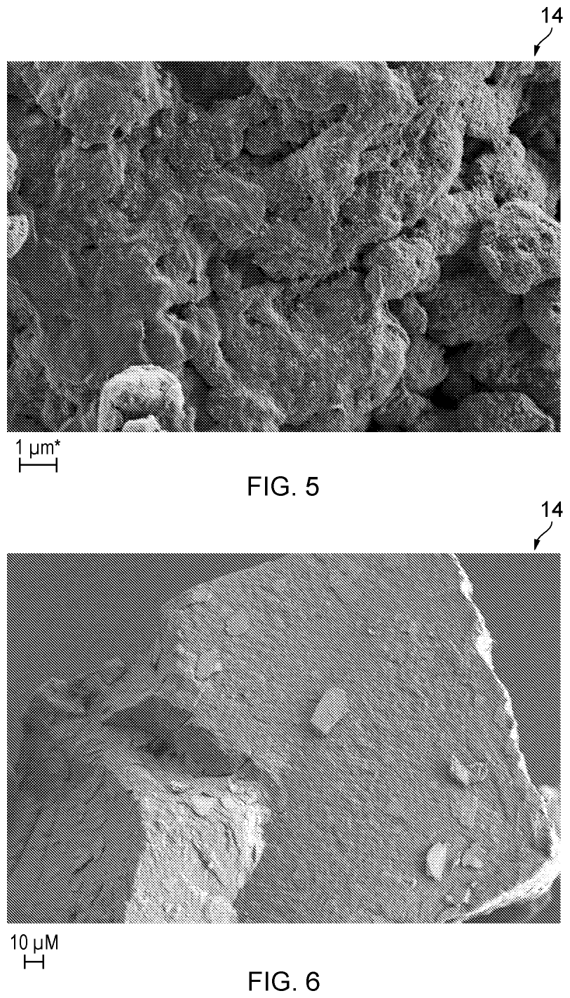

FIG. 5 illustrates a treated or modified polymer; and

FIG. 6 illustrates a treated or modified polymer.

### DETAILED DESCRIPTION

Examples of the disclosure relate to a method for producing a treated or modified polymer. In some examples, an additive material or filler material is dispersed in a compatible carrier liquid, such as water, using techniques such as high shear mixing and/or ultrasonic dispersion or sonication.

In examples, the highly dispersed filler/additive material is mixed in a vessel containing a suspension of polymer which may be in the form of a powder, in a carrier liquid. In some examples the carrier liquids may be the same liquid and any suitable liquid may be used.

In examples, the method provides for production of the treated or modified polymer at relatively low temperatures and relatively low pressures. For example, the temperature might be less than 120° C. and the pressure might be less than 250 kPa. This provides technical advantages such as a reduction in the required heating and therefore the required power requirements in producing the treated or modified polymer and also allows for production of a treated or modified polymer using materials which may suffer degradation using higher temperature processes.

Furthermore, in examples where water is used as the carrier liquid technical advantages are provided due to the non-toxic nature of water which allows for safe and convenient disposal of the carrier liquid following production of the treated or modified polymer and safer production of the treated or modified polymer due to there being no toxic gases and so on produced during the production process.

The combining of the additive material with the polymer to produce the treated or modified polymer can enhance various features of the polymer. For example, electrical conductivity, strength, stiffness, toughness and so on can be enhanced depending on the additive material and polymer chosen.

FIGS. 1 and 2 illustrate a method 100, 200 for producing a treated or modified polymer 14, the method 100, 200 comprising:

combining a first liquid and at least one additive material 12, to produce a first liquid and additive material mixture;

agitating the first liquid and additive material mixture to disperse the at least one additive material 12, throughout the first liquid;

combining a second liquid and a polymer 10, to wet the polymer 10, to produce a wetted polymer; and

combining the agitated first liquid and additive material mixture with the wetted polymer to produce a treated or modified polymer 14.

FIG. 3 illustrates a treated or modified polymer 14, comprising polymer particles 10, having additive particles 12 adhered to the outside of the polymer particles 10.

FIG. 3 also illustrates a treated or modified polymer 14 produced using a method 100, 200 as described herein.

FIGS. 1 and 2 illustrate a method 100, 200 for producing a modified thermoplastic polymer 10, the method comprising:

combining water with graphene to produce a water and graphene mixture;

agitating the water and graphene mixture to homogenously disperse the graphene throughout the water;

combining water with a thermoplastic polymer to wet the thermoplastic polymer to produce a wetted thermal plastic polymer;

combining the water and graphene mixture with the wetted thermoplastic polymer, wherein the weight of the graphene, as a proportion of the weight of the thermoplastic polymer, is greater than 0 percent and less than or equal to 5 percent.

FIG. 1 illustrates a method 100 for producing a treated or modified polymer 14. A schematic example of the treated or modified polymer 14 is illustrated in the example in FIG. 3.

At block 102 a first liquid and at least one additive material 12 are combined to produce a first liquid and additive material mixture. The at least one additive material may be considered to be comprised of additive particles.

In examples, the first liquid may be considered a carrier liquid and any suitable liquid may be used as the first liquid.

For example, a suitable liquid should not react adversely with or cause any significant degradation of the polymer 10 used in the method 100 (see block 106) or of the additive material 12 in the conditions of the method 100. Said differently, the first liquid might be substantially chemically inert to the polymer 10 and the additive material 12 in the method 100, 200 (i.e. under the conditions of the method 100, 200, while the method 100, 200 is carried out). Furthermore, a suitable liquid should not act as a good solvent for the polymer 10 and should remain as a liquid at a temperature and pressure used in the method 100.

The first liquid may comprise an organic liquid. Suitable organic liquids include, but are not limited to, toluene, N, N-dimethylformamide, and chloroform.

In some examples, the first liquid comprises non-organic liquid, such as water.

The use of water as the first liquid provides advantages as water can be readily and safely disposed of following use in the method 100 and does not cause toxic gases to be created during production of the treated or modified polymer 14.

In examples, the first liquid in block 102 may comprise a plurality of different liquids.

The at least one additive material 12, may comprise any suitable additive material or materials.

In examples, the at least one additive material 12 comprises at least one functional filler material. In some examples, the at least one functional filler material has a one, two or three-dimensional structure. For example, the at least one additive material 12 may comprise functional filler(s) having two-dimensional structure(s).

The at least one additive material 12 may be selected from but not limited to carbon black, graphite, expanded graphite, short carbon fibres, graphene, graphene oxide, carbon nanotubes, metal particles, fumed SiO2, TiO2, MgO, short glass fibres, mineral fillers, ceramic particles or fibres, natural montmorillonite, clays or any combination thereof.

In examples, the at least on additive material 12 can have any suitable particle size. For example, the at least one additive material may be considered a nanomaterial, such as a nanofiller, for example, fumed SiO2, carbon black and/or graphene.

In some examples, the mean particle size of the at least one additive material 12 is less than 100 micrometres. In some examples, the mean particle size of the at least one additive material is in the range 1 nanometer to 100 micrometres or 5 nanometers to 100 micrometers.

In examples, the at least one additive material 12 comprises a plurality of different additive materials. For example, the at least one additive material 12 may comprise two, three, four and so on different additive materials.

In some examples, the at least one additive material 12 is insoluble or almost insoluble in the first liquid and/or second liquid (see block 106 of FIG. 1).

Any suitable method may be used to combine the first liquid and the at least one additive material 12. For example, the first liquid, in a first vessel, may be added to additive material 12 in a second, different vessel.

In some examples, the at least one additive material 12 in a first vessel, may be added to the first liquid in a second different vessel.

At block 104 the first liquid and additive material mixture is agitated to disperse the at least one additive material throughout the first liquid, creating a dispersion. For example, the first liquid and additive material mixture may be agitated to homogenously disperse the at least one additive material 12 throughout the first liquid, creating a suspension.

In many cases, a surfactant or a compatibilization agent is not necessary to create the dispersion/suspension.

Any suitable method may be used to agitate the first liquid and additive material mixture to disperse the at least one additive material 12 throughout the first liquid.

In examples, agitating the first liquid and additive material mixture comprises high shear mixing and/or ultrasonic dispersion or sonication. The use of high shear mixing and/or ultrasonic dispersion provides for the at least one additive material 12 to be highly dispersed throughout the first liquid.

In some examples, the first liquid and additive material mixture may be agitated for any suitable length of time. For example, the first liquid and additive material mixture may be agitated for a period in the range 2 minutes to 200 minutes, for example in the range 5 minutes to 30 minutes. In some examples the first liquid and additive material mixture may be agitated for a period in the range of 10 minutes to 20 minutes.

In some examples the first liquid and additive material mixture is passed into a cell with a small volume relative to the volume of the first liquid and additive material to be agitated, for example by ultrasonication. In such examples the agitation time may be relatively short, for example in the range 10 to 30 seconds.

At block 106 a second liquid and a polymer 10 are combined to wet the polymer 10 to produce a wetted polymer 10.

In examples, the second liquid may be considered a carrier liquid. Any suitable liquid may be used as the second liquid.

A suitable liquid for use as the second liquid may be as the suitable liquids described in relation to the first liquid at block 102.

The second liquid should not react adversely with or cause any significant degradation of the polymer 10 used in the method 100 or of the additive material 12 in the conditions of the method 100. Said differently, the second liquid might be substantially chemically inert to the polymer 10 and the additive material 12 in the method 100, 200 (i.e. under the conditions of the method 100, 200, while the method 100, 200 is carried out).

In examples, the second liquid comprises an organic liquid such as those listed above in relation to the first liquid at block 102.

In some examples, the second liquid comprises water which provides advantages as detailed above in relation to block 102.

Accordingly, in the examples the first liquid and/or second liquid comprises an organic liquid. In some examples, the first liquid and/or second liquid comprises water. In examples, the first liquid is the same as the second liquid.

The polymer 10 may comprise any suitable polymer 10 or polymers 10. The polymer 10 may be considered to be comprised of (macroscopic) polymer particles.

In examples, the polymer 10 is selected from nylons, polystyrenes, poly(methyl methacrylates), polycarbonates, poly(ethylene terephthalates), poly(ether sulphones), poly(butyl terephthalates), poly(ethyl methacrylates) and high melting point olefin-based copolymers such as Polyether ether ketone, Polyaryl ether ketone and/or Polyether ketone ketone.

In some examples the polymer 10 comprises a thermoplastic.

A wide range of thermoplastic polymers can be used in the method 100 for example a homopolymer, copolymer or a blended polymer. By way of example, thermoplastics that are suitable for use in the method 100 include: acrylonitrile butadiene styrene (ABS), acrylic, celluloid, cellulose acetate, ethylene-vinyl acetate (EVA), ethylene vinyl alcohol (EVAL), fluoroplastics (including FEP, PFA, CTFE, PTFE, ECTFE, ETFE), ionomers, acrylic/PVC alloy, polyacetal, polyacrylates, polyacrylonitrile (PAN), polyamide (PA), polyamide-imide (PAI), polyaryletherketone (PAEK), polybutadiene (PBD), polybutylene terephthalate (PBT), polychlorotrifluoroethylene (PCTFE), polyethylene terephthalate (PET), polycyclohexylene dimethylene terephthalate (PCT), polycarbonate (PC), polyhydroxyalkanoates (PHAs), polyketone (PK), polyester, co-polyester, polyolefins such as polyethylene (PE), polypropylene (PP), polybutylene (PB), polymethylpentene (PMP), and olefin-based copolymers, polyetheretherketone (PEEK), Polyaryl ether ketone (PAEK), Polyether ketone ketone (PEKK), polyetherimide (PEI), polyethersulphone (PES), polyethylenechlorinates (PEC), polyimide (PI), polylactic acid (PLA), polyphenylene oxide (PPO), polyphenylene sulphide (PPS), polyphthalamide (PPA), polystyrene (PS), polysulphone (PSU), polyvinylchloride (PVC), polyvinylidenechloride (PVdC), plasticised starches, polyhydroxybutyrate (PHB), and polyvinyl alcohol (PVA or PVOH).

Preferred polymers for use in examples include nylons, polyethylene, polypropylene, polystyrene, poly(methyl methacrylate), poly(vinyl chloride), poly(vinyl acetate), polycarbonate, polycaprolactone, poly(ethylene oxide), poly(vinyl alcohol), poly(ethylene terephthalate), poly(ether sulphone), poly(butyl terephthalate), poly(ethyl methacrylate), ultrahigh molecular weight polyethylene. Particularly preferred polymers 10 include nylons, polystyrene, poly(methyl methacrylate), polycarbonate, poly(ethylene terephthalate), poly(ether sulphone), poly(butyl terephthalate), poly(ethyl methacrylate) and high melting point olefin-based copolymers such as polyetheretherketone.

The polymer 10 may be particulate and may be amorphous, semi-crystalline or crystalline before it is heated. The method 100 is applicable to single polymers 10 and to mixtures of different polymers. For example, the polymer 10 may be a mixture of polymers 10 of the same composition but of different molecular weight, or chemically different polymers.

In examples, the polymer 10 is in the form of a powder or pellets. In some examples, the mean particle size of the polymer 10 is in the range 0.3 micrometres to 600 micrometres. In some examples the mean particle size of the polymer 10 is in the range of 20 micrometres to 300 micrometres. In some examples, the mean particle size of the polymer 10 is in the range 50 micrometres to 150 micrometres. For example, in examples the mean particle size of the polymer 10 is 100 micrometres.

In some examples the size of 80% of the polymer particles is within plus or minus 20 micrometres of the mean value.

In some examples, the at least one additive material 12 is chosen in dependence upon the polymer 10 that is to be used. For example, the at least one additive material 12 may be chosen in dependence upon the property of the polymer 10 that is to be enhanced or added. In examples, carbon black may be used as at least part of the at least one additive material 12 to increase electrical conductivity of a polymer 10.

In examples, the amount of the polymer 10 may be selected in dependence upon the amount of the at least one additive material 12 used. Alternatively, the amount of the at least one additive material 12 may be chosen in dependence upon the amount of the polymer 10 to be used.

In some examples, the weight of the at least one additive material 12, as a proportion of the weight of the polymer 10, is in the range 0.01% to 10%, 0.01% to 5% or 0.01% to 3%.

In some examples, the weight of the at least one additive material 12, as a proportion of the weight of the polymer 10, is in the range 5% to 8%.

In some examples, such as examples where the at least one additive material 12 comprises graphene and the polymer 10 comprises a thermoplastic polymer, the weight of the at least one additive material 12, as a proportion of the weight of the polymer 10, is greater than 0% and less or equal to 15%. In some examples the weight of the at least one additive material 12, as a proportion of the weight of the polymer 10, is greater than 0% and less than or equal to 5%.

Any suitable method may be used to combine the second liquid and polymer 10 to wet the polymer to produce a wetted polymer.

For example, the second liquid in a first vessel may be added to the polymer 10 in a second, separate vessel. In some examples, the polymer 10 may be added to the second liquid similarly.

A mechanical stirrer, for example, may be used to combine the second liquid and polymer 10 to wet the polymer to produce a wetted polymer.

In some examples the second liquid is stirred to create a vortex and the polymer 10, for example polymer powder, poured in to the vortex. This technique provides for efficient wetting of the polymer 10 irrespective of the polymer type.

In examples, combining the second liquid and polymer 10 produces a second liquid and polymer mixture and the method 100 comprises heating the second liquid and polymer mixture while wetting the polymer.

In some examples, the method 100 comprises heating the second liquid and polymer mixture to a temperature greater than 50° C. while wetting the polymer.

In examples, the second liquid and polymer mixture is heated to a temperature in the range of 80° C. to 90° C. at a pressure of around 100 kPa. In examples the second liquid and polymer mixture is mixed for a period of time in the range 2 minutes to 150 minutes.

In some examples the period of mixing is dependent upon the addition technique, the polymer 10 and its density.

When the second liquid and polymer 10 have been combined to wet the polymer a suspension in the form of a polymer slurry may be produced.

In examples, the mean particle size of the at least one additive material 12 is chosen in dependence upon the mean particle size of the polymer 10.

This is because the method 100 produces a modified or treated polymer 14 having additive particles 12 adhered/attached to the outside of the polymer particles (see the example of FIG. 3). Accordingly, the mean particle size of the at least one additive material 12 may be chosen in dependence upon the mean particle size of the polymer 10 to allow the additive material 12 to adhere/attach to the outside of the polymer particles 10.

In some examples, the amount of additive material 12 by weight of polymer 10 may be chosen in dependence of the particle size of the polymer 10. This is because the particle size of the polymer 10 may dictate how much additive material 12 can adhere/attach to the outside of the polymer particles 10.

In some examples, mixing can be carried out at any suitable temperature, typically between 0° C. and 80° C., and is typically carried out at ambient temperatures, approximately 20° C.

At block 108 the agitated first liquid and additive material mixture is combined with the wetted polymer to produce a treated or modified polymer 14.

In examples, any suitable method may be used to combine the agitated first liquid and additive material mixture with the wetted polymer to produce the treated or modified polymer 14. For example, combining the agitated first liquid and additive material mixture with the wetted polymer to produce a treated or modified polymer 14 may comprise heating and/or agitation.

In examples, combining the agitated first liquid and additive material mixture with the wetted polymer comprises heating the first/second liquid, polymer and additive mixture that is produced by combining the agitated first liquid and additive material mixture with the wetted polymer.

In examples, the first/second liquid, polymer and additive mixture is heated to a temperature greater than 100° C. and less than 125° C. at a pressure of 100 kPa to 250 kPa.

However, the heating can be carried out at any suitable temperature from 75° C. up to 150° C. and the temperature used may be dependent on the polymer 10 used. In examples, the temperature used is considerably below the melting point of the polymer.

For example LDPE, which has a melting point of 130° C., and PEEK, which has a melting point of 341° C., can be used in the method 100 at a temperature of 125° C. and a pressure of 234 kPa.

In examples, the method comprises elevating the pressure of the first/second liquid, polymer and additive mixture during heating to prevent the first and/or second liquid from boiling. This may be done by placing the combined agitated first liquid and additive material mixture and wetted polymer in a suitable vessel to allow the pressure to be elevated to prevent boiling of the first and/or second liquid during the heating process.

Following block 108 a treated or modified polymer 14 is produced comprising polymer particles having additive particles adhered/attached to the outside of the polymer particles.

In examples, the elevated temperature applied to the combination of the agitated first liquid and additive material mixture and the wetted polymer is maintained for sufficient time to allow the additive material particles to adhere/attach to the surface of the polymer particles.

For example, the elevated temperature may be maintained for a period in the range 1 minute to 20 minutes, or 5 minutes to 10 minutes.

In some examples combining the agitated first liquid and additive material mixture with the wetted polymer to produce a treated or modified polymer 14 comprises agitation. This can ensure that good contact is maintained between the polymer particles and the filler particles.

The agitation may, in examples, comprise stirring, shaking or any other suitable form of agitation.

The treated or modified polymer 14 may exhibit beneficial characteristics compared to the polymer 10 prior to treatment.

For example, dependent on the additive material(s) used the treated or modified polymer 14 may exhibit increased strength, flexibility, stiffness, electrical conductivity or any suitable combination of these or other characteristics.

The method 100, 200 and the combination of the at least one additive material and the polymer in this way provide clear advantages.

For example, the use of relatively low temperatures (for example less than 120° C.) allows for the use of less expensive equipment in producing the treated or modified polymer 14.

Furthermore, the use of relatively low temperatures allows for less expensive equipment to be used to prevent carrier liquids such as water from boiling.

Moreover, some polymers such as polyethylene terephthalate (PET) can hydrolyse if heated near to their melting point. Accordingly, the use of the method 100, 200 disclosed herein allows for production of treated or modified polymers 14 including such polymers without hydrolysing the polymer 10 or with minimal hydrolysis of the polymer 10.

Also, as the additive materials 12 are so well dispersed and adhered/attached to the polymer 10 the additive material cannot clump which reduces production of “nano-dust” which can produce a safety hazard.

The method 100 is also advantageous where nano fillers having low dry packing densities are concerned. By taking the nano particles into suspension in water, for example, and attaching them to the polymer particles it is possible to introduce both the nano filler and polymer into a twin-screw extruder.

It is otherwise very difficult to screw feed low dry packing density nano fillers into a twin screw extruder because the material does not feed properly and floats away into the air. It is easy to put such particles into suspension by, for example, shaking them in a closed vessel with water.

It is suggested that the method 100 allows the at least one additive material 12 to adhere/attach to the outside of the polymer 10 by the first and/or second liquids aiding the adhesion of the additive material 12 to the outside of the polymer 10 at the temperatures discussed herein.

Accordingly the method 100 produces a treated or modified polymer comprising polymer particles having additive particles adhered/attached to the outside of the polymer particles.

In some examples the additive particles are only adhered/attached to the surface of the polymer particles or are predominantly adhered/attached to the surface of the polymer particles.

In examples, the treated or modified polymer 14 produced using the method 100, 200 can be selectively melted or sintered using a local source of heat to form an article of manufacture and/or to provide powder for sintering, such as laser sintering.

Accordingly, examples of the disclosure provide for an article of manufacture comprising a treated or modified polymer 14 as disclosed herein.

FIG. 2 illustrates a method 200 for producing a treated or modified polymer 14.

In the example of FIG. 2 the blocks 202, 204, 206 and 208 are equivalent to blocks 102, 104, 106 and 108 of FIG. 1 and may be as described in relation to FIG. 1.

At block 201 the treated or modified polymer 14 is cooled. The method 200 therefore comprises, in examples, cooling the treated or modified polymer 14.

In examples, any suitable method for cooling the treated or modified polymer 14 may be used. For example, one or more suitable fluids and/or liquids may be passed over/through the treated or modified polymer 14 and/or the vessel(s) containing the treated or modified polymer 14 to cool the treated or modified polymer 14. In some examples, the treated or modified polymer 14 and/or the vessel(s) containing the treated or modified polymer 14 may be run under water to cool the treated or modified polymer 14.

The treated or modified polymer 14 may be cooled while still under pressure introduced at block 208. In such examples, the treated or modified polymer 14 may be agitated in any suitable way to ensure good contact is maintained between the polymer particles and the filler particles during cooling under pressure.

At block 211 liquid is removed from the treated or modified polymer 14. Accordingly, the method 200 comprises, in examples, removing the liquid from the treated or modified polymer 14. For example, the liquid may be removed from the treated or modified polymer 14 by filtering the treated or modified polymer 14 from the liquid.

In examples, any suitable method for removing the liquid from the treated or modified polymer 14 may be used. For example, removing the liquid may comprise filtering the treated or modified polymer from the liquid.

Any suitable filter may be used for example a sock, such as a nylon sock may be used to filter the treated or modified polymer 14 from the liquid.

In examples, the filter has a size in the range of 10 micrometers to 300 micrometers, for example in the range 15 micrometres to 30 micrometres. In some examples, the filter may have a size of approximately 20 micrometres.

In some examples, block 211 may be considered filtering the treated or modified polymer 14.

At block 212 the treated or modified polymer 14 is dried. Accordingly, the method 200 comprises, in examples, drying the treated or modified polymer 14.

Any suitable method for drying the treated or modified polymer may be used. For example, the treated or modified polymer may be placed at an elevated temperature to dry the treated or modified polymer 14.

In some examples, the treated or modified polymer may be heated to a temperature of greater than 100° C. (e.g. at ambient/atmospheric pressure), for example 110° C. to dry the treated or modified polymer. In some examples, the drying of the treated or modified polymer is done at a temperature in the range 100° C. to 120° C.

In some examples, a vacuum oven is used to dry the treated or modified polymer 14 at temperatures below 100° C. This is advantageous for low melting point polymers such as Poly Lactic Acid (PLA) and so on.

The temperature used for drying the treated or modified polymer 14 may be selected on the basis of the advised temperature for drying the polymer 10 used in the method 100, 200. In examples, the treated or modified polymer 14 is dried until there is less than 1% liquid by weight of the treated or modified polymer 14.

At block 214 the dried, treated or modified polymer is combined with at least one further additive material.

Accordingly, the method 200 comprises, in examples, combining the dried, treated or modified polymer 14 and at least one further additive material.

In examples, any suitable further additive material may be used. In some examples, one or more additive materials discussed in relation to block 102 of FIG. 1 may be used.

The dried treated or modified polymer and the at least one further additive material may be combined using any suitable method, such as physical mixing.

In examples, the combining of the dry, treated or modified polymer 14 with at least one further additive material can provide beneficial characteristics, for example surfactant or compatibilizer. The at least one further additive material may be selected from, but not limited to, one or more of aluminium, silver, nano TiO2, glass powder, fumed SiO2 and so on.

At block 216 the treated or modified polymer 14 is extruded. Accordingly, in examples, the method 200 comprises extruding the treated or modified polymer 14.

In examples, any suitable method for extruding the treated or modified polymer 14 may be used.

In examples, the modified or treated polymer 14 is extruded to form a final product, or to form pellets that can be subsequently formed into a final product.

In examples, the treated or modified polymer 14 may be used in sintering processes such as laser sintering processes.

The method 100, 200 is particularly advantageous where high melting point polymers are concerned because it avoids the need for expensive high-pressure reactors that would otherwise be required to achieve a temperature close to their melting point. It is particularly useful with polymers such as polyethylene terephthalate (PET) which has both a high melting point and hydrolyses rapidly in contact with water at temperatures in excess of about 150° C. The hydrolysis is minimised when the process is operated in water at 120° C.

FIG. 3 illustrates an example of a treated or modified polymer 14.

FIG. 3 is a schematic illustration of three polymer particles. In the example of FIG. 3 the polymer particles have additive particles adhered/attached to the outside of the polymer particles. The treated or modified polymer 14 illustrated in the example of FIG. 3 is produced using the method 100, 200.

A chemical reaction between the polymer 10 and the additive material 12 need not occur in the method 100, 200. This is because the polymer 10 and the additive material 12 can be selected such that they are substantially chemically inert to one another in the method 100, 200 (i.e. under the conditions of the method 100, 200, while the method 100, 200 is carried out). The additive particles might be adsorbed to the outer surface of the polymer particles. It is thought that the adhesion/attachment of the additive particles to the outer surface of polymer particles might occur through the Van der Waals force, which provides an attraction between a polymer particle and one or more additive particles.

Accordingly, FIG. 3 illustrates a treated or modified polymer comprising polymer particles having additive particles adhered/attached to the outer surface of the polymer particles. In examples the additive particles are physically adhered to the outer surface of the polymer particles.

In examples, the polymer particles and additive particles may be one or more of those described in relation to FIG. 1 and/or FIG. 2 and therefore the polymer particles and additive particles may be as described in relation to one or both of those figures.

In the example of FIG. 3 the polymer particles are schematically illustrated as circular.

However, in examples the polymer particles may have any shape.

Similarly, in FIG. 3 the additive material is schematically illustrated as a single line on the surface of the polymer particle. However, in examples the additive material may have any suitable shape.

Examples of the disclosure will now be further and more particularly described in the following examples.

### Example 1

China Clay that is sold in a dispersible form was shear mixed in the weight ratio of 60 China Clay to 40 water for 10 minutes in a high shear mixer. This may for example use a high shear mixer operated at 7,000 rpm. The slurry was then subjected to intense ultrasound for a further 10 minutes. This may for example use a 300 W ultrasonic horn at 20 kHz. Polyethylene terephthalate (PET) with a melting point of 197° C. and in the form of polymer particles with a typical diameter of 100 microns was mixed with water in a weight ratio of 50 PET to 50 water and continuously stirred in an open pressure vessel until the polymer was wetted. The highly dispersed China Clay slurry was added to the stirred PET in the weight ratio of 3.0 clay to 97.0 PET. The mixture was then stirred and heated to between 80 and 90° C. in a pressure vessel and the pressure vessel closed. Heating continued until a temperature of 121° C. and a pressure of 207 kPa was reached and that temperature and pressure were held for 5 minutes. At the end of the heating cycle the pressure vessel was cooled to below 100° C., opened and the contents discharged into a filter sock. The separated polymer clay composite powders were then dried in a warm kiln at about 100° C. for 24 hours.

The dry polymer powders were then introduced into a twin-screw compounder. In the compounding and extrusion process the materials are subjected to mixing at elevated temperatures. The parameters used are as follows.

Typical machine barrel temperature settings: subject to polymer grade

Nozzle: 280-300° C.; Front: 265-295° C.; Centre: 260-295° C.; Rear: 260-290° C.; melt temperature: 275-300° C.

The compounder is provided with an outlet extrusion die to produce a sheet 1 mm thick which is then passed through a set of three chilling and finishing rollers, producing a final film thickness of 0.97 mm.

### Example 2

Carbon nanotube in the form of a fine powder was mixed with water in a weight ratio of 1:1000. To ensure that the graphene was dispersed, the mixture was then subjected to intense ultrasound for 10 minutes. This may for example use a 300 W ultrasonic horn at 20 kHz.

Polyamide powder with a size range of 40-60 microns was mixed with water in a weight ratio of 50 Polyamide to 50 water in a pressure vessel using a rotary stirrer. The pressure vessel was heated to about 80° C. and once the powder was dispersed and wetted, sufficient quantity of the carbon nanotube slurry was added to the polymer slurry such that the weight ratio was 0.01 Graphene to 99.99 Polyamide. The pressure vessel was closed and heating continued until a temperature of 121° C. and a pressure of 207 kPa were achieved. This temperature was held for 5 minutes and the reactor vessel cooled to below 100° C. The liquid was separated from the composite powder by simple filtration through a finely woven nylon filter sock. The powder was then dried for 24 hrs in shallow trays placed in a conventional oven held at 110° C.

The polyamide composite powder was then introduced into a selective laser sintering machine and the particles directly sintered together using a 250W CO₂ laser with a spot size at the powder bed of 0.6 mm. A raster pattern was used with an overlap between adjacent scan lines of 50% of the spot size. The thickness of the powder layers was 0.125 mm.

### Example 3

Zirconium dioxide with nano dimensions in the range 10 to 20 nm in diameter was supplied in an aqueous solution by weight 5 parts of Zirconia to 995 parts of water. The slurry was then subjected to intense ultrasound for 10 minutes. This may for example use a 300 W ultrasonic horn at 20 kHz.

Polyethylene terephthalate (PET) with a melting point of 197° C. and in the form of polymer particles with a typical diameter of 100 microns was mixed with water in a weight ratio of 50 PET to 50 water and continuously stirred in a pressure vessel until the polymer was wetted. The highly dispersed Zirconia solution was added to the stirred PET in the weight ratio of 1.0 Zirconia to 99.0 PET. The mixture was then stirred and heated to between 80 and 90° C. and the pressure vessel closed. Heating continued until a temperature of 121° C. and a pressure of 207 kPa were reached and that temperature was held for 5 minutes. At the end of the heating cycle the pressure vessel was cooled to below 100° C., opened and the contents discharged into a filter sock. The separated PET/Zirconia composite powders were then dried in a warm kiln at about 100° C. for 24 hours.

The dry polymer powders were then introduced into a twin-screw compounder. In the compounding and extrusion process the materials are subjected to mixing at elevated temperatures. The parameters used are as follows.

Typical machine barrel temperature settings: subject to polymer grade

Nozzle: 280-300° C.; Front: 265-295° C.; Centre: 260-295° C.; Rear: 260-290° C.; melt temperature: 275-300° C.

The compounder is provided with an outlet extrusion die to produce a sheet 1 mm thick which is then passed through a set of three chilling and finishing rollers, producing a final film thickness of 0.97 mm.

FIG. 4A illustrates an example of a polymer 10.

In the example of FIG. 4A the polymer 10 is Nylon 12 powder and FIG. 4A is a scanning electron microscope image of the Nylon 12 powder at a magnification of 1.79 k times.

FIG. 4B illustrates an example of a treated or modified polymer 14.

In the example of FIG. 4B, the treated or modified polymer 14 is Nylon 12 powder with 3% weight multiwall carbon nanotubes (MWCNT). The treated or modified polymer 14 in the example of FIG. 4B is produced using the method 100.

The image in FIG. 4B is a scanning electron microscope image of the surface of Nylon 12 powder/3% weight multiwall carbon nanotubes (MWCNT) at a magnification of 10K times.

It can be seen from the example of FIG. 4B that the treated or modified polymer 14 has additive particles adhered to the outside of the polymer particles.

FIG. 5 illustrates an example of a treated or modified polymer 14.

In the example of FIG. 5 the treated or modified polymer 14 is Nylon PA12 with 1% weight Nano TiO2. The image shown in FIG. 5 is a scanning electron microscope image at a magnification of 20 k times.

The example of FIG. 5 also shows polymer particles having additive particles adhered to the outside of the polymer particles.

FIG. 6 illustrates an example of a treated or modified polymer 14.

In the example of FIG. 6 the treated or modified polymer 14 is Nylon PA12 with 0.1% weight graphene.

In the example of FIG. 6 the image is a scanning electron microscope image at a magnification of 1 k times.

It can be seen from the example of FIG. 6 that the graphene platelets are adhered to the surface of the Nylon PA12.

Examples of the disclosure provide various technical advantages. For example, the operation of the method 100, 200 at relatively low temperatures allows for use of less expensive equipment in the production of a treated or modified polymer.

Furthermore, the operation of the method 100, 200 at relatively low temperatures allows the method 100, 200 to be used with polymers that can hydrolyse at higher temperatures.

Moreover, the use of water as a carrier liquid provides for safe, convenient production of treated or modified polymer without requiring particular disposal or operating safety requirements.

It is intended that the term “for”, as used herein, also includes “configured or arranged to”.

The blocks illustrated in the FIGS. 1 and 2 may represent steps in a method and/or sections of code in the computer program. The illustration of a particular order to the blocks does not necessarily imply that there is a required or preferred order for the blocks and the order and arrangement of the block may be varied. Furthermore, it may be possible for some blocks to be omitted. For example, block 214 and/or block 216 in FIG. 2 may be omitted in some examples.

Additionally or alternatively, in FIGS. 1 and 2 some blocks may be performed in a different order and/or contemporaneously with other blocks.

Where a structural feature has been described, it may be replaced by means for performing one or more of the functions of the structural feature whether that function or those functions are explicitly or implicitly described.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class. It is therefore implicitly disclosed that features described with reference to one example but not with reference to another example, can where possible be used in that other example but does not necessarily have to be used in that other example.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

I/We claim:

1.-47. (canceled)

48. A method for producing a treated or modified polymer, the method comprising:
combining a first liquid and at least one additive material to produce a first liquid and additive material mixture;
agitating the first liquid and additive material mixture to disperse the at least one additive material throughout the first liquid;
combining a second liquid and a thermoplastic polymer to produce a thermoplastic polymer slurry; and
combining the agitated first liquid and additive material mixture with the thermoplastic polymer slurry to produce a treated or modified thermoplastic polymer comprising thermoplastic polymer particles having additive particles adhered to the outside of the thermoplastic polymer particles.

49. The method as claimed in claim 48, wherein the at least one additive material comprises at least one functional filler material.

50. The method as claimed in claim 49, wherein the at least one functional filler material has a one, two, or three-dimensional structure.

51. The method as claimed in claim 48, wherein a weight of the at least one additive material, as a proportion of the weight of the thermoplastic polymer, is in a range 0.01% to 10%.

52. The method as claimed in claim 48, wherein a mean particle size of the at least one additive material is less than 100 micrometres.

53. The method as claimed in claim 48, wherein at least one of the first liquid or second liquid comprises an organic liquid.

54. The method as claimed in claim 48, wherein at least one of the first liquid or the second liquid comprises water.

55. The method as claimed in claim 48, wherein a mean particle size of the thermoplastic polymer is in a range 0.3 micrometres to 600 micrometres.

56. The method as claimed in claim 48, wherein agitating the first liquid and additive material mixture comprises high shear mixing and/or ultrasonic dispersion.

57. The method as claimed in claim 48, wherein the first liquid is identical to the second liquid.

58. The method as claimed in claim 48, wherein combining the second liquid and thermoplastic polymer produces a second liquid and thermoplastic polymer mixture and the method comprises heating the second liquid and thermoplastic polymer mixture while wetting the thermoplastic polymer.

59. The method as claimed in claim 58, wherein the second liquid and thermoplastic polymer mixture is heated to a temperature greater than 50 degrees Celsius.

60. The method as claimed in claim 48, wherein combining the agitated first liquid and additive material mixture with the thermoplastic polymer slurry comprises heating the first/second liquid, thermoplastic polymer and additive mixture that is produced by combining the agitated first liquid and additive material mixture with the thermoplastic polymer slurry.

61. The method as claimed in claim 60, wherein one or more of the first or second liquid, the thermoplastic polymer, and the additive mixture are heated to a temperature greater than 100 degrees Celsius and less than 125 degrees Celsius.

62. The method as claimed in claim 60, further comprising elevating a pressure of one or more of the first or second liquid, the thermoplastic polymer, and the additive mixture during heating to prevent the at least one of the first liquid or the second liquid from boiling.

63. The method as claimed in claim 48, wherein the thermoplastic polymer is selected from nylons, polystyrenes, poly(methyl methacrylates), polycarbonates, poly(ethylene terephthalates), poly(ether sulphones), poly(butyl terephthalates), poly(ethyl methacrylates) and high melting point olefin-based copolymers.

64. The method as claimed in claim 48, wherein the at least one additive material is selected from carbon black, graphite, expanded graphite, short carbon fibres, graphene, graphene oxide, carbon nanotubes, metal particles, fumed SiO2, TiO2, MgO, short glass fibres, mineral fillers, ceramic particles or fibres, natural montmorillonite, clays or any combination thereof.

65. The method as claimed in claim 48, wherein the at least one additive material is chemically inert to the thermoplastic polymer in the method.

66. A method for producing a modified thermoplastic polymer, the method comprising:
combining water with graphene to produce a water and graphene mixture;
agitating the water and graphene mixture to homogenously disperse the graphene throughout the water;
combining water with a thermoplastic polymer to wet the thermoplastic polymer to produce a wetted thermoplastic polymer; and
combining the water and graphene mixture with the wetted thermoplastic polymer, wherein a weight of the graphene, as a proportion of the weight of the thermoplastic polymer, is greater than 0% and less than or equal to 5%.

67. A method for producing a treated or modified thermoplastic polymer, the method comprising:
combining a first liquid and at least one additive material to produce a first liquid and additive material mixture;
agitating the first liquid and additive material mixture to disperse the at least one additive material throughout the first liquid;
combining a second liquid and a thermoplastic polymer to produce a thermoplastic polymer slurry; and
combining the agitated first liquid and additive material mixture with the thermoplastic polymer slurry to produce a treated or modified thermoplastic polymer, wherein the at least one additive material is chemically inert to the thermoplastic polymer in the method.
